(19) United States
(12) Patent Application Publication
(10) Pub. No.: US 2006/0292517 A1
(43) Pub. Date: Dec. 28, 2006

(54) Tooth brace visual indicia

(76) Inventor: Fred Smith, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/453,291

(22) Filed: Jun. 14, 2006

Related U.S. Application Data
(60) Provisional application No. 60/690,744, filed on Jun. 15, 2005.

(51) Int. Cl. A61C 3/00

(52) U.S. Cl. 433/13

(57) ABSTRACT

Tooth brace visual indicia for a brace system for human teeth, including an indicia apparatus for engagement with at least one component of a brace system for human teeth. The indicia apparatus includes an attaching carrier removably attachable to the at least one component of the brace system, and the attaching carrier is in operational engagement with or integrally formed with visual indicia. A visual indicia system and a method of providing visual indicia are also disclosed.

### CROSS REFERENCE TO RELATED APPLICATIONS

This application claims priority under 35 U.S.C. § 119(e) from provisional U.S. Patent Application No. 60/690,744, filed Jun. 15, 2005, the contents of which are incorporated herein by reference.

### BACKGROUND OF THE INVENTION

1. Field of Invention

The present invention relates generally to brace systems for adjusting human teeth and, in particular, to tooth brace visual indicia, an indicia apparatus and a method of providing visual indicia for a brace system.

2. Description of the Prior Art

In the field of dentistry and orthodontics, braces are used to assist in adjusting the angle and displacement of human teeth. As the technology of manufacturing and applying braces to human teeth develops, the market and class of target patients increase accordingly. Both children and adults utilize braces to straighten their teeth for aesthetic reasons. Further, braces are also used to correct and/or prevent medical mishaps leading from improperly placed or growing teeth in the human mouth.

While the patient certainly desires and enjoys the results of utilizing braces, many patients, particularly children, dislike the appearance of the brace when applied. In order to reduce the metallic appearance of the braces in the mouth, clear braces, or partially clear braces, have been developed. However, while these transparent or partially transparent braces are an improvement over the metallic braces, an enhanced aesthetic quality is required. In order to increase the aesthetic quality of the appearance of a person's braces, the use of a phosphorescent or fluorescent pigment applied to the braces has been conceived. See U.S. Pat. No. 5,592,895 to Farrokh et al. This same colorizing technique applied directly to a human tooth has also been developed, as seen in U.S. Pat. No. 6,036,494 to Cohen. Further aesthetic improvement with increased expression for use in conjunction with braces is required.

### SUMMARY OF THE INVENTION

It is, therefore, one object of the present invention to provide tooth brace visual indicia that overcomes the drawbacks and deficiencies of the prior art. It is another object of the present invention to provide tooth brace visual indicia that result in an improved aesthetic quality to a human brace. It is a still further object of the present invention to provide tooth brace visual indicia that may be removably attachable to at least one component of a brace system.

The present invention is directed to an indicia apparatus for engagement with at least one component of a brace system for human teeth. The indicia apparatus includes an attaching carrier removably attachable to at least one component of the brace system. Further, the attaching carrier is in operational engagement with or integrally formed with visual indicia.

The present invention is further directed to a visual indicia system. The system includes a brace system for human teeth, which includes a plurality of brace brackets each configured to be attached to a surface of a human tooth. Each brace bracket has multiple, spaced wing elements extending from a brace bracket base and forming a brace bracket groove. The brace system also includes a wire member for extension through the brace bracket groove of the brace bracket. In addition, the visual indicia system includes an attaching carrier removably attachable to at least one component of the brace system. The attaching carrier in operational engagement with or integrally formed with visual indicia.

The present invention is still further directed to a method of providing visual indicia for a brace system for human teeth. The method includes the steps of: providing an indicia apparatus comprising an attaching carrier in operational engagement with or integrally formed with visual indicia; and removably connecting the attaching carrier to at least one component of the brace system.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1a is a front view of a typical brace bracket and brace system according to the prior art;

FIG. 1b is a side view of the brace bracket of FIG. 1a;

FIG. 1c is an edge view of the brace bracket of FIG. 1a;

FIG. 2a is a front view of a first embodiment of an indicia apparatus according to the present invention;

FIG. 2b is a side view of the embodiment in FIG. 2a when attached to a brace bracket;

FIG. 2c is a front view of the embodiment in FIG. 2a when attached to a brace bracket;

FIG. 3a is a front view of a second embodiment of an indicia apparatus according to the present invention;

FIG. 3b is a side view of the embodiment in FIG. 3a when attached to a brace bracket;

FIG. 3c is a side view of a further arrangement of the embodiment in FIG. 3a when attached to a brace bracket;

FIG. 4a is a third embodiment of an indicia apparatus according to the present invention when attached to a brace bracket;

FIG. 4b is an edge view of the embodiment in FIG. 4a when attached to a brace bracket;

FIG. 4c is a side view of a further arrangement of the embodiment in FIG. 4a when attached to a brace bracket;

FIG. 5a is a front view of a fourth embodiment of an indicia apparatus according to the present invention;

FIG. 5b is a side view of the embodiment in FIG. 5a when attached to a brace bracket;

FIG. 6a is a front view of one embodiment of visual indicia system according to the present invention;

FIG. 6b is a side view of the embodiment of FIG. 6a;

FIG. 6c is a top view of the embodiment of FIG. 6a;

FIG. 7a is a front view of a fifth embodiment of an indicia apparatus according to the present invention when attached to a brace bracket;

FIG. 7b is a side of the embodiment of FIG. 7a;

FIG. 8a is a front view of a sixth embodiment of an indicia apparatus according to the present invention;

FIG. 8b is a side view of the embodiment of FIG. 8a;

FIG. 9a is a front view of a seventh embodiment of an indicia apparatus according to the present invention;

FIG. 9b is a side view of the embodiment of FIG. 9a;

FIG. 10a is a front view of an eighth embodiment of an indicia apparatus according to the present invention;

FIG. 10b is a side view of the embodiment of FIG. 10a;

FIG. 11a is a front view of a ninth embodiment of an indicia apparatus according to the present invention;

FIG. 11b is a side view of the embodiment of FIG. 11a;

FIG. 12a is a front view of a tenth embodiment of an indicia apparatus according to the present invention;

FIG. 12b is a side view of the embodiment of FIG. 12a;

FIG. 13a is a front view of a eleventh embodiment of an indicia apparatus according to the present invention; and

FIG. 13b is a side view of the embodiment of FIG. 13a.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

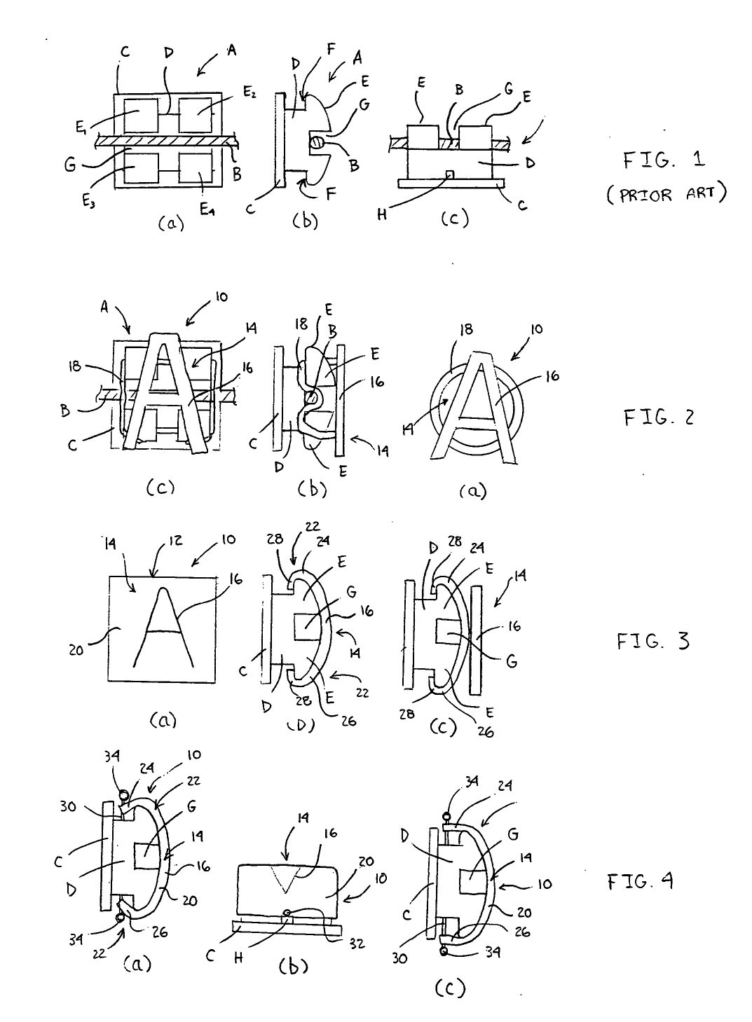

In the field of corrective dentistry, various brace systems are used to adjust a person's tooth or teeth in order to obtain an appropriate and healthy alignment. In order to achieve this appropriate alignment, the brace system typically uses a series of brace brackets A, where each bracket A is attached to a respective tooth. Next, a wire B is engaged with the brackets A and adjusted to slowly urge the teeth into the proper alignment. FIGS. 1a-1c are various views of a brace bracket A according to the prior art.

As seen in FIGS. 1a-1c, the brace bracket A includes a brace bracket base C, which is removably attachable to a human tooth. Typically, an adhesive is applied to one side of the brace bracket base C, such that the brace bracket A can be attached to the tooth. Extending outwardly from the brace bracket base C is a brace bracket transition portion D, which terminates in multiple and spaced wing elements E. In particular, and according to the prior art, four wing elements E are provided, including a first wing element E₁, a second wing element E₂, a third wing element E₃ and a fourth wing element E₄.

According to the prior art, these wing elements E are generally sloped, but may include a variety of shapes and contours, as is known in the art. Each of these wing elements E extend over an end of the brace bracket transition portion D, thereby creating a wing element groove F extending on an underside portion of each wing element E. Typically, the wing elements E are square in shape and slope from an inner edge towards the edges of the brace bracket transition portion D and rounding and terminating in the wing element groove F.

Running essentially through the spaced wing elements E is a brace bracket groove G, which is used for placing the brace wire B against the brace bracket A. It is this brace wire B that is used to at least partially secure the brace bracket A to each individual human tooth. In addition, near a base area of the brace bracket transition portion D, immediately adjacent the brace bracket base C is a brace bracket slot H. This brace bracket slot H extends through and the length of the brace bracket transition portion D. In this manner, a brace system is provided for use in correcting the alignment of a person's teeth.

With respect to the present invention, and as seen in various embodiments in FIGS. 2-5 and 7-13, the present invention is directed to an indicia apparatus 10. This indicia apparatus 10 is used for and engaged with at least one component of a brace system, as discussed above. In addition, the indicia apparatus 10 includes an attaching carrier 12, which is removably attachable to the component of the brace system, such as the brace bracket A, the brace wire B, etc. Still further, the attaching carrier 12 is either in operational engagement with or integrally formed with visual indicia 14. While any type of visual indicia 14 is envisioned, in various preferred embodiments, the visual indicia 14 may be a letter, a symbol, a number, a word, a phrase, a color, etc. In this manner, words and phrases and other informational expressions can be created through the use of multiple attaching carriers 12 having visual indicia 14.

As seen in a first embodiment in FIGS. 2a-2c, the attaching carrier includes visual indicia 14 in the form of a symbol 16, which is attached to or integrally formed with an elastic ring 18. The symbol 16 may be either rigid or elastic, depending upon the application and the amount of stretching involved. The elastic ring 18 is similar in size and shape to an A-lastic, which is the elastic band or ligature and typically used to secure the brace wire B to the brace bracket A. In use, the attaching carrier 12 is positioned centrally on the face of the brace bracket A, and the elastic ring 18 is stretched over one or more of the wing elements E and allowed to contract or retract into one or more of the respective ring element grooves F. Accordingly, the attaching carrier 12 is secured to the brace bracket A and oriented such that the symbol 16 is visible to an observer when the user opens his or her mouth.

When attached, the elastic ring 18 of the attaching carrier 12 serves to hold the brace wire B within the brace bracket groove G. Further, it is also envisioned that the symbol 16 can be utilized to secure the brace wire B in the brace bracket groove G. When multiple attaching carriers 12 are used on multiple teeth in the user's mouth, words, phrases and other informational statements can be displayed on the user's braces. In addition, as the attaching carrier 12 is removable, the user may simply remove and replace different attaching carriers 12, thereby spelling out different words and phrases.

A second embodiment of an indicia apparatus 10 according to the present invention is illustrated in FIGS. 3a-3c. As shown in FIG. 3a, the attaching carrier 12 of the second embodiment is in the form of an attaching carrier substrate 20 having multiple engagement members 22. As with the previous embodiment, this second embodiment of the attaching carrier 12 includes visual indicia 14 attached thereto or integrally formed therewith. As seen in FIG. 3, the attaching carrier 12 includes a first engagement member 24 and a second engagement member 26. The first engagement member 24 is sized and shaped so as to engage with a first pair of adjacent wing elements E (such as wing element E₁ and wing element E₂) while the second engagement member 26 is sized and shaped to engage with a second pair of adjacent wing elements E (such as wing element E₃ and wing element E₄).

Also as illustrated in connection with the second embodiment, the first engagement member 24 and the second engagement member 26 are in the form of curved gripping portions 28, which are sized and shaped and extend over the respective pair of wing elements E. Further, FIG. 3c illustrates another arrangement of this second embodiment, where the symbol 16 (as a separate element or disposed on a separate, attachable substrate) is attached to the attaching carrier substrate 20, as opposed to being integrally formed with the attaching carrier substrate 20.

In operation, the attaching carrier substrate 20 is placed on the face of the brace bracket A. As the attaching carrier 20 of this embodiment is flexible or bendable, the first engagement member 24 and second engagement member 26 (or curved gripping portions 28) are positioned over the respective pair of wing elements E and bent or flexed into the wing element grooves F. In this manner, the attaching carrier 12 is secured to the brace bracket A. Of course, it is also envisioned that the engagement members are slid over (e.g., laterally) the wing elements E.

In the third embodiment of the present invention, and as shown in FIGS. 4a-4c, a similar attaching carrier substrate 20 is used with respect to the second embodiment. However, in order to further secure the attaching carrier 12 to the brace bracket A, a pin 30 is used. This pin 30 is connected to each end of the first engagement member 24 and second engagement member 26 after inserting the pin 30 through the brace bracket slot H. In addition, the first engagement member 24 and second engagement member 26 may be provided with apertures 32 for inserting the pin 30 therethrough.

In operation, the pin 30 is inserted through an aperture 32 on one of the first engagement members 24 or second engagement members 26, pushed through the brace bracket slot H, and then through the aperture 32 on the other of the first engagement member 24 or second engagement member 26. Once the pin 30 is appropriately positioned, one or more attachers 34 are secured to each end of the pin 30. In this embodiment, the attachers 34 are spherical female screw tops, which are manufactured to mate with threads on each end of the pin 30. Any suitable method of attaching or securing the pin 30 to the first engagement member 24 and second engagement member 26 is envisioned.

As discussed above in connection with the previous embodiment, the engagement member 22 of this third embodiment can be used to secure the brace wire B in the brace bracket groove G, obviating the need for an A-lastic. In another arrangement, and as illustrated in FIG. 4c, the first engagement member 24 and second engagement member 26 are not sloped to mate directly over the wing elements E. Such contouring or sloping would not be required since the pin 30 serves to secure the attaching carrier 12 to the brace bracket A.

A fourth embodiment of the indicia apparatus 10 of the present invention is shown in FIGS. 5a-5b. The fourth embodiment is similar to the third embodiment discussed above, in that an attaching carrier substrate 20 and pin 30 arrangement secures the attaching carrier 12 to the brace bracket A. However, in the present embodiment, the attaching carrier substrate 20 is magnetized. Further, the attaching carrier substrate 20 has a visual indicia slot 36 located on a face of the attaching carrier substrate 20. This visual indicia slot 36 is sized and shaped to accept or mate with the visual indicia 14, which is also magnetized. In addition, the visual indicia 14 is in the form of a visual indicia substrate 38, which is configured for operational engagement with the attaching carrier 12 or attaching carrier substrate 20. In operation, since the attaching carrier substrate 38 is magnetized, as is the visual indicia slot 36 of the attaching carrier substrate 20, the visual indicia 14 may be removed and replaced easily by the user.

As discussed above, and in this embodiment, the attaching carrier substrate 20 may also serve to secure the brace wire B in the brace bracket groove G. However, in this embodiment, the user may remove the visual indicia substrate 30 (or visual indicia 14) from the visual indicia slot 36 and magnetically place other visual indicia substrates 38 in the visual indicia slot 36. One benefit of this fourth embodiment is that the entire attaching carrier substrate 20 and pin 30 structure need not be removed from the brace bracket A in order to change the visual indicia 14 visible on the brace bracket A.

It is envisioned that the attaching carrier 12 can be uniformly or diversely colored. For example, in the first embodiment discussed above, it would be preferable that the elastic ring 18 be clear, while the symbol 16 be a highly visible color, such as a blaze orange. This would increase the visibility and effect of the present invention. Similarly, in any of the embodiments discussed herein, different colors could be used to allow the visual indicia 14 to stand out and be more easily visible.

A visual indicia system according to the present invention is illustrated in FIGS. 6a-6c. In this embodiment, a modified brace bracket 40 is utilized. In particular, the wing elements 42 are not sloped, but instead include a substantially flush front face 44. Extending from the front face 44 of each wing element 42 is multiple slots 46. In one preferred embodiment, side slots 48 extend from a peripheral portion of the wing elements 42, and end slots 50 extend from a bottom portion of wing elements 42. In this manner, a retainment groove 52 is created.

In this embodiment of the indicia apparatus 10, the attaching carrier 12, which includes the visual indicia 14, is sized and shaped such that it can be slid into the slots 46, and specifically in a mating arrangement with the retainment groove 52. Accordingly, the attaching carrier 12 is removably attachable to the brace bracket 40, and further, the attaching carrier 12 retains the brace wire B in the brace bracket groove G. Still further, in this fifth embodiment, the visual indicia 14 is raised or elevated from a face of the attaching carrier 12, thereby creating a 3-dimensional effect. Of course, it is also envisioned that the visual indicia 14 can be recessed within the attaching carrier 12.

In order to retain the attaching carrier 12 within the retainment groove 52, the attaching carrier 12 may also include one or more projections 54, such as bumps or raised portions, extending from the face thereof. These projections 54 would be sized and shaped so as to interact with matching and aligned indents 56 on the wing elements 42 of the brace bracket 40. In operation, the attaching carrier 12 would be slid down into the retainment groove 52 until the projections 54 engage with respective indents 56, and the attaching carrier 12 would “lock” into place. Such a function would also ensure proper alignment of the attaching carrier 12 with respect to the brace bracket A. It is also envisioned that the projections 54 could be disposed on the wing elements 42, while the matching indents 56 would be positioned on the attaching carrier 12.

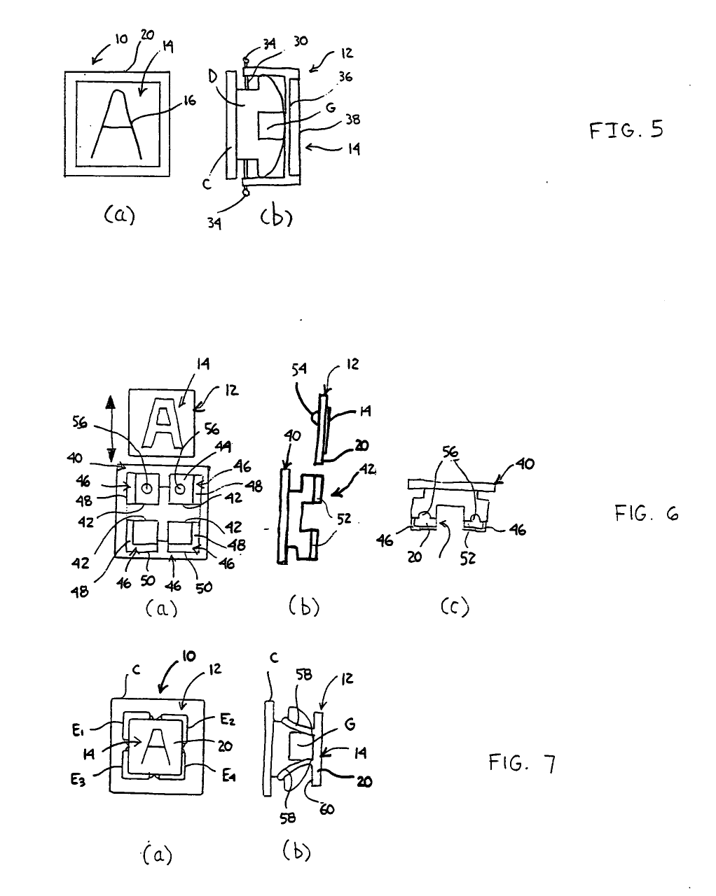

A fifth embodiment of the indicia apparatus 10 is illustrated in FIGS. 7a-7b. In this embodiment, the attaching carrier 12 includes the above-discussed attaching carrier substrate 20. However, multiple elastic members 58 are attached to a portion of the attaching carrier substrate 20. For example, in this fifth embodiment, the elastic members 58 are attached to a rear surface 60 of the attaching carrier substrate 20. The visual indicia 14 is positioned on or integral with the attaching carrier substrate 20. In operation, the elastic members 58 are stretched over one or more of the wing elements B of the brace bracket A, until the attaching carrier substrate 20 is secured to the brace bracket A. In this embodiment, the attaching carrier substrate 20 would assist in securing the brace wire B within the brace bracket groove G. In addition, in this embodiment, the elastic members 58 are formed with the attaching carrier substrate 20.

A sixth embodiment of the present invention is illustrated in FIGS. 8a-8b. In this embodiment, an A-chain 62 is formed, and this A-chain 62 is formed of multiple and connected attaching carrier substrates 20. Specifically, an elastic connector 64 connects multiple substrates 20 together to form this A-chain 62, and, as discussed above, multiple elastic members 58 extend from the rear surface 60 of each respective attaching carrier substrate 20. Further, the present embodiment illustrates the use of raised or projecting visual indicia 14.

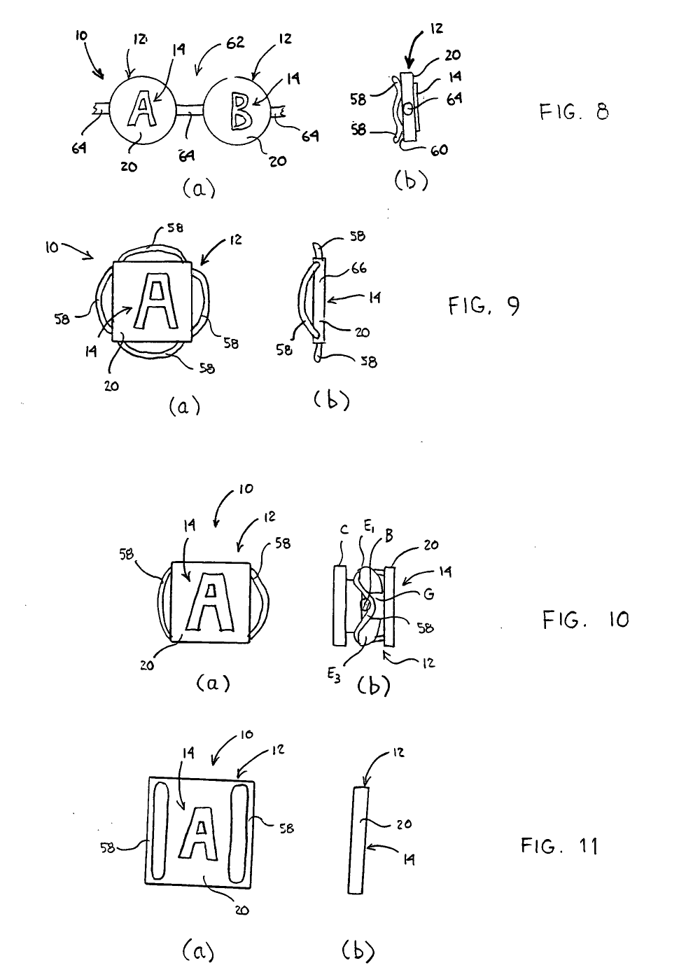

A seventh embodiment of an indicia apparatus 10 according to the present invention is illustrated in FIGS. 9a-9b. In this embodiment, the attaching carrier 12 is integrally formed with the visual indicia 14 thereon. Further, multiple elastic members 58 are used and extend from an edge surface 66 of the attaching carrier substrate 20. Specifically, the attaching carrier substrate 20 is in a square-shaped form, and an elastic member 58 is attached to and extends from a respective edge surface 56 of the attaching carrier substrate 20. Accordingly, the attaching carrier 12 includes four elastic members 58 each configured to be stretched over one or more wing elements E.

In an eighth embodiment, and as seen in FIGS. 10a-10b, two elastic members 58 extend from a surface (such as the rear surface 60 of the attaching carrier substrate 20 or the edge surface 66 of the attaching carrier substrate 20), and these elastic members 58 are used not only to attach the indicia apparatus 10, but also to bear against the brace wire B. Specifically, the elastic members 58 are each pulled over a respective pair of wing elements E (in this case, wing element E₁ and E₃ are a pair, and wing elements E₂ and E₄ are another pair). Since the elastic members 58 are attached to the sides of the attaching carrier substrate 20, they are also used to bear against and retain the brace wire B in the brace bracket groove G.

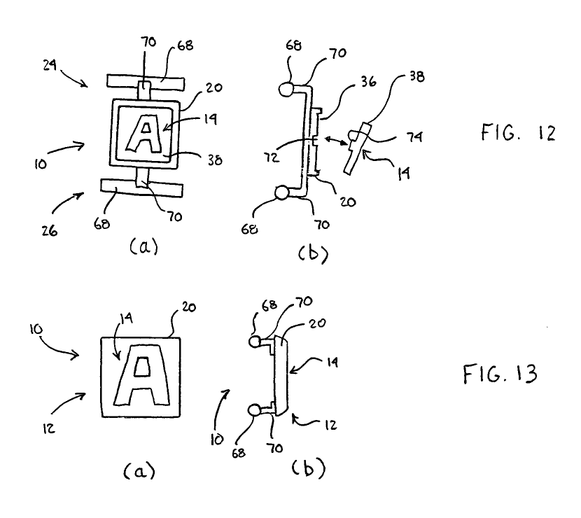

A ninth embodiment of the present invention is illustrated in FIGS. 11a-11b. In this embodiment, the elastic members 58 are integrally formed with the attaching carrier substrate 20, as discussed above in connection with the eighth embodiment. However, due to the method of formation, these elastic members 58 are reinforced and able to stand up to additional wear and tear. As discussed above in connection with the previous embodiment, the elastic members 58 are simply slid over a respective pair of wing elements E, and also serve to bear against the brace wire B. Of course, if these elastic members 58 were disposed on the top and bottom portions of the attaching carrier substrate 20, they would not bear against the brace wire B. However, in such an arrangement, the attaching carrier substrate 20 would still serve to retain the brace wire B within the brace bracket groove G by nature of its positioning against the brace bracket A.

FIGS. 12a-12b illustrate a tenth embodiment of the indicia apparatus 10 according to the present invention. In particular, the first engagement member 24 and second engagement member 26 (as discussed above in connection with various of the embodiments) are in the form of an engagement bar 68. The engagement bar 68 is attached to a surface of the attaching carrier substrate 20 by means of an extension member 70. The extension member 70 is sized and shaped so as to extend through at least a portion of a transverse bracket groove I (such as between wing elements E₁ and E₂) of the brace bracket A. In addition, each engagement bar 68 is sized and shaped so as to engage behind a respective pair of wing elements E, and specifically within the wing element grooves F.

In this tenth embodiment, the attaching carrier substrate 20 includes a visual indicia slot 36 for receiving a visual indicia substrate 38 therein. In addition, a recess 72 is formed within the visual indicia slot 36. This recess 72 is sized and shaped so as to accept a projection 74 on a rear surface of the visual indicia substrate 38. For example, the recess 72 and projection 74 may be configured for a frictional fit, thereby removably retaining the visual indicia substrate 38 within the visual indicia slot 36 of the attaching carrier substrate 20.

An eleventh embodiment of the indicia apparatus 10 is illustrated in FIGS. 13a-13b. As discussed above in connection with the tenth embodiment, the present embodiment also includes multiple engagement bars 68 attached to the attaching carrier substrate 20 via extension member 70. However, in this eleventh embodiment, the attaching carrier substrate 20 is of a greater size and allows for greater visibility of the visual indicia 14.

It is also envisioned that the indicia apparatus 10 of the present invention can be used in connection with other known brace systems, such as a ligature-less brace bracket. Such a bracket typically includes an openable and closeable door on the front of the bracket, which hinged and opens upwards. This door may be used as the attaching carrier substrate 20 and/or visual indicia substrate 38 for carrying and/or displaying the visual indicia 14. For example, the visual indicia substrate 38 could be removably attachable to the bracket door, or the door could be manufactured integrally with visual indicia 14. Therefore, the indicia apparatus 10 of the present invention could be a component of a brace system integrally formed with or attached to the visual indicia 14. Accordingly, the broad concept of utilizing visual indicia in connection with a brace system for human teeth is within the scope of the present invention.

In this manner, the present invention provides an indicia apparatus, tooth brace visual indicia and methods of providing visual indicia to a brace system that provides additional aesthetic quality to human braces. In addition, the present invention is beneficial in that the user can change the attaching carriers 12 him or herself, without the need for a professional's help. This will allow a person to modify the expression on the braces, or remove all visual indicia 14 from the braces, if desired. Overall, the present invention decreases the unsightliness and self-conscienceness that typically goes along with the use of braces, especially in children. In addition, the present invention allows the user to express him or herself via the visual indicia 14 and also the change the expression as often as he or she would like.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. An indicia apparatus for engagement with at least one component of a brace system for human teeth, the indicia apparatus comprising an attaching carrier removably attachable to the at least one component of the brace system, the attaching carrier in operational engagement with or integrally formed with visual indicia.

2. The apparatus of claim 1, wherein the attaching carrier is configured for direct or indirect attachment to a brace bracket, a brace wire or any combination thereof.

3. The apparatus of claim 1, wherein the brace system includes a plurality of spaced wing elements extending from a brace bracket base, each wing element having a wing element groove extending on an underside portion thereof, wherein the visual indicia is integrally formed with the attaching carrier, which comprises an elastic member configured to be stretched over at least one wing element and retract into the wing element groove.

4. The apparatus of claim 1, wherein the brace system includes a plurality of spaced wing elements extending from a brace bracket base, the attaching carrier comprising an attaching carrier substrate having a plurality of engagement members configured to engage with at least one wing element.

5. The apparatus of claim 4, wherein the attaching carrier substrate includes a first engagement member configured to engage with at least one of a first pair of adjacent wing elements, and a second engagement member configured to engage with at least one of a second pair of adjacent wing elements.

6. The apparatus of claim 5, wherein the first engagement member and the second engagement member comprise a curved gripping portion configured to engage over the respective pair of wing elements.

7. The apparatus of claim 5, wherein each wing element includes a wing element groove extending on an underside portion thereof and the brace bracket further comprises at least one bracket groove extending between the spaced wing elements, wherein the first engagement member and the second engagement member each comprise an engagement bar attached to a surface of the attaching carrier substrate by an extension member, wherein the extension member is configured to extend through at least a portion of the bracket groove, and the engagement bar is configured to engage in the wing element groove of a pair of adjacent wing elements.

8. The apparatus of claim 4, wherein the engagement members are flexible and configured to flexed over and contacted with at least one of the wing elements.

9. The apparatus of claim 1, wherein the visual indicia comprises a visual indicia substrate configured for operational engagement with or integrally formed with the attaching carrier.

10. The apparatus of claim 9, wherein the visual indicia member is removably attachable to a portion of the attaching carrier.

11. The apparatus of claim 9, wherein a pair of adjacent visual indicia substrates are connected by an elastic connector.

12. The apparatus of claim 1, wherein the brace system includes a plurality of wing elements extending from a brace bracket base, each wing element having a wing element groove extending on an underside portion thereof, wherein the attaching carrier includes a plurality of elastic members extending from a portion of an attaching carrier substrate, each of the plurality of elastic members configured to be stretched over the at least one wing element and retract into the wing element groove.

13. The apparatus of claim 12, wherein the attaching carrier comprises four elastic members, each extending from a surface of the attaching carrier substrate and configured to be stretched over at least one wing element.

14. The apparatus of claim 12, wherein the attaching carrier comprises two elastic members, each extending from a surface of the attaching carrier substrate and configured to be stretched over at least one wing element.

15. The apparatus of claim 12, wherein at least one of the plurality of elastic members are reinforced.

16. The apparatus of claim 1, wherein the visual indicia comprises a letter, a symbol, a number, a word, a phrase, a color or any combination thereof.

17. A visual indicia system, comprising:
a brace system for human teeth, including:
(i) a plurality of brace brackets each configured to be attached to a surface of a human tooth, each brace bracket having a plurality of spaced wing elements extending from a brace bracket base and forming a brace bracket groove; and
(ii) a wire member configured to extend through the brace bracket groove of the brace bracket; and
an attaching carrier removably attachable to at least one component of the brace system, the attaching carrier in operational engagement with or integrally formed with visual indicia.

18. A method of providing visual indicia for a brace system for human teeth, the method comprising the steps of:
providing an indicia apparatus comprising an attaching carrier in operational engagement with or integrally formed with visual indicia; and
removably connecting the attaching carrier to at least one component of the brace system.

19. The method of claim 18, wherein the attaching carrier is configured for direct or indirect attachment to a brace bracket, a brace wire or any combination thereof.

20. The method of claim 18, wherein the visual indicia comprises a letter, a symbol, a number, a word, a phrase, a color or any combination thereof.
